(19) United States
(12) Patent Application Publication
(10) Pub. No.: US 2010/0110309 A1
(43) Pub. Date: May 6, 2010

(54) PORTABLE ELECTRONIC DEVICE WITH MULTIMEDIA FUNCTION

(75) Inventor: YI-AN TSAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/506,346

(22) Filed: Jul. 21, 2009

(30) Foreign Application Priority Data
Oct. 31, 2008 (CN) 200810305342.9

(51) Int. Cl. H04N 9/31; G06F 1/32

(52) U.S. Cl. 348/744; 713/320; 348/E09.025

(57) ABSTRACT

A portable electronic device with multimedia function includes a central processing unit, and a projection module, a multimedia information management module, a power management module all electronically connected to the central processing unit. The projection module projects multimedia signals of the electronic device onto a surface to display the multimedia signals. The multimedia information management module classifies and selects to play the multimedia signals under the control of the central processing unit. The power management module sets a power consumption mode under the control of the central processing unit in accordance with multimedia signals format.

### BACKGROUND

1. Technical Field

The disclosure relates to portable electronic devices, particularly, to a portable electronic device having a multimedia function.

2. Description of Related Art

Portable electronic devices, such as mobile telephones and personal digital assistants (PDAs), generally have a multimedia function for playing audios, pictures or videos. Generally, people enjoy viewing pictures or watching videos on large screens. But the current development trend of light, thin, short and small makes portable electronic devices have small screens. Therefore, portable electronic devices with built-in projectors are becoming popular.

However, built-in projectors create heat and consume a lot of power and so the electronic device can only be used for short periods of time.

Therefore, there is a room for improvement within the art.

### BRIEF DESCRIPTION OF THE DRAWINGS

Many aspects of the present portable electronic device with multimedia function can be better understood with reference to the following drawings. The components in the drawings are not necessarily to scale, the emphasis instead being placed upon clearly illustrating the principles of the present portable electronic device with multimedia function. Moreover, in the drawings, like reference numerals designate corresponding parts throughout the several views:

FIG. 1 is a diagram of a portable electronic device and a display area, according to an exemplary embodiment.

FIG. 2 is a diagram of the portable electronic device projecting images or videos onto the display area, according to the exemplary embodiment.

### DETAILED DESCRIPTION OF THE EMBODIMENTS

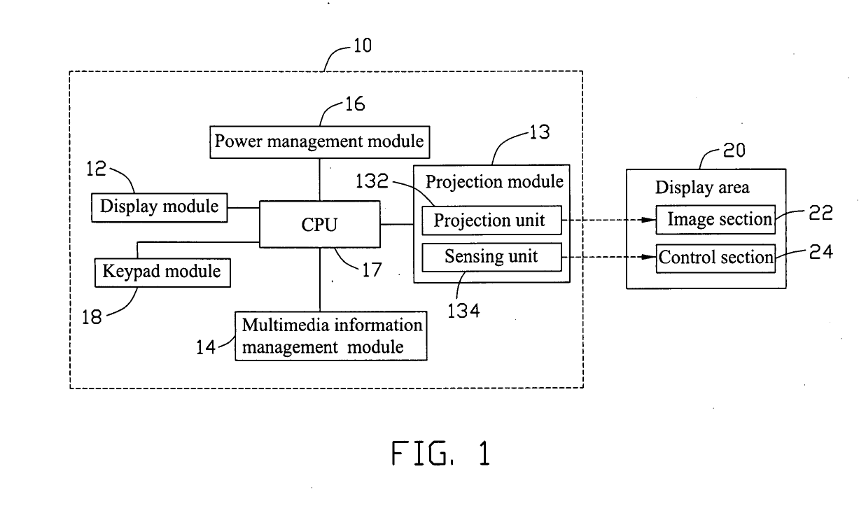

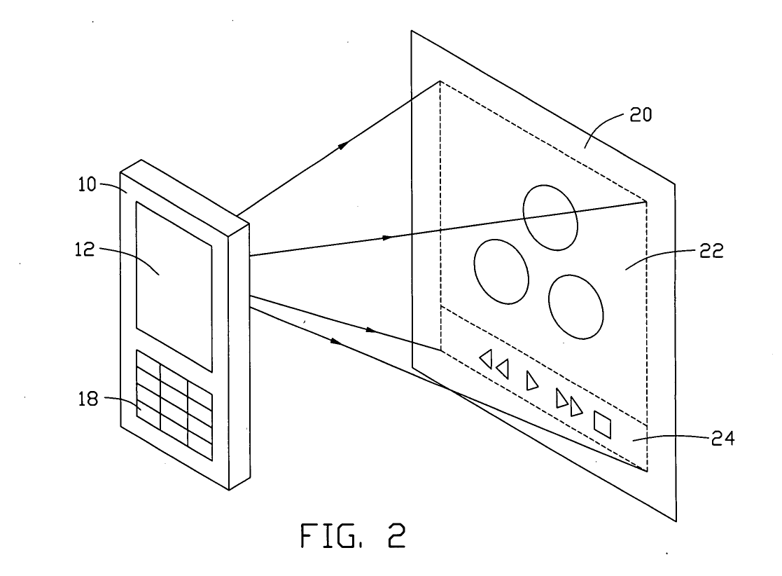

Referring to FIGS. 1-2, an exemplary embodiment of a portable electronic device 10 with a projection module 13 for projecting pictures or videos onto any suitable surface such as wall or an included projection surface of the electronic device 10. In operation, the projection module 13 projects an interactive display area 20 onto the surface. The display area 20 is divided into two sections, an image section 22 and a virtual control section 24. The control section 24 may be a projection of, for example, a virtual keyboard in proximity of the image section 22. The image section 22 is configured for displaying the pictures or videos output by the projection module 13. The virtual control section 24 is used to control the pictures or videos displayed in the image section 22.

The portable electronic device with multimedia function 10 includes a display module 12, a projection module 13, a multimedia information management module 14, a power management module 16, a central processing unit (CPU) 17, and a keypad module 18. The display module 12, the projection module 13, the multimedia information management module 14, the power management module 16, and the keypad module 18 are electronically connected to the CPU 17.

The display module 12 can display various operation instructions, and display such things as lyrics, pictures, videos etc. In the exemplary embodiment of the portable electronic device 10, the display module 12 is a display unit of the portable electronic device 10, such as a liquid crystal display module (LCM), and so on.

The projection module 13 is used to project the pictures or videos onto the display area 20. The projection module 13 includes a projection unit 132 and a sensing unit 134. The projection unit 132 can be combined with an existing projector chip. The sensing unit 134 can be integrated with an existing virtual keyboard chip. When a user operates any virtual key of the control section 24, the sensing unit 134 senses/receives a light reflected from the fingers of the user, and the sensing unit 134 converts the reflected light to a corresponding electrical signal and sends the electrical signal to the CPU 17.

The multimedia information management module 14 is configured for classifying the multimedia files stored in the electronic device 10 as audio or picture/video. The multimedia information management module 14 is also configured for reading resolutions of the pictures or videos, and automatically comparing the resolutions of the pictures or videos with the resolution of the display module 12. The resolutions of the pictures or videos can be displayed on the display module 12.

The power management module 16 is used to manage the power of the electronic device 10. When the projection module 13 is in use, the power management module 16 enters a high power consumption mode. When the projection module 13 is not in use, the power management module 16 enters a low power consumption mode.

Furthermore, if the power management module 16 is in the low power consumption mode by command of the user, but the resolutions of the pictures or videos are greater than the screen resolution of the display module 12, then the projection module 13 is automatically started under the control of the CPU 17. The pictures or videos are projected on the image section 22 and the power management module 16 enters the high power consumption mode. If the resolution of the pictures or videos are less than or equal to the screen resolution of the display module 12, the power management module 16 remains in the low power consumption mode. Understandably, the projection module 13 can be manually controlled by the user to select the power consumption mode.

The CPU 17 controls the display module 12 to display various multimedia files. The CPU 17 controls the projection module 13 to project the pictures or not. The multimedia information module 14 is configured for storing, sending and processing the multimedia files under the control the CPU 17. The power management module 16 selects the power mode under the control of the CPU 17.

The keypad module 18 can be combined with an existing keyboard device. The keypad module 18 is configured for sending a control signal to the CPU 17, so that the electronic device 10 can enter the multimedia function mode and select the power consumption mode under the control of the CPU 17.

In use, first the keypad module 18 sends a control signal to the CPU 17, then the electronic device 10 enters the multimedia function mode controlled by the CPU 17. The user operates the keypad module 18 to select the high power consumption mode or the low power consumption mode. For example, when the audio files are played, the power management module 16 enters the low power consumption mode. If the pictures or videos are played, the multimedia information module 14 firstly reads the resolutions of the pictures or videos, and compares the resolutions of the pictures or videos with the resolution of the display module 12, then the power management module 16 can enter either the low power consumption mode or the high power consumption mode.

If the power management module 16 is in the low power consumption mode, but the resolutions of the pictures or videos are greater than the screen resolution of the display module 12, then the projection module 13 will start and the pictures or videos can be viewed more clearly. When the projection module 13 is in use, the pictures or videos are projected onto the image section 22 and the power management module 16 enters the high power consumption mode. Thereby, people can selectively use the projection module 13 according to the resolutions of the pictures or videos to manage power and still enjoy viewing the pictures or watching the videos.

The multimedia information management module 14 selects to play the multimedia format, such as audios, pictures or videos. The power management module 16 selectively selects whether to start the projection module 13, so that the projection module 13 can project the pictures or videos onto the display area 20. Thereby, the electronic device 10 not only can play the pictures or videos clearly, but also can maximally save the power of the electronic device 10 to meet the needs of the users.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A portable electronic device with multimedia function, comprising:
a central processing unit;
a projection module electronically connected to the central processing unit, and the projection module projecting multimedia signals of the electronic device onto a surface to display the multimedia signals;
a multimedia information management module electronically connected to the central processing unit, classifying the multimedia signals and choosing to play the multimedia signals under the control of the central processing unit; and
a power management module electronically connected to the central processing unit, and setting power consumption mode under the control of the central processing unit in accordance with the classification of the multimedia format.

2. The portable electronic device with multimedia function as claimed in claim 1, wherein when the multimedia information management module plays the multimedia signals, the power management module selects a low power consumption mode or a high power consumption power consumption mode based on the multimedia format and the resolutions of the multimedia signals.

3. The portable electronic device with multimedia function as claimed in claim 2, wherein when the power management module selects the low power consumption mode, the multimedia signals are displayed on the electronic device.

4. The portable electronic device with multimedia function as claimed in claim 2, wherein when the power management module selects the high power consumption mode, the central processing unit drives the projection module to project the multimedia signals onto the surface.

5. The portable electronic device with multimedia function as claimed in claim 2, wherein when the power management module selects the low power consumption mode, the multimedia information management module compares the resolutions of the multimedia files with the screen resolution of the electronic device, and the power management power module selects the power consumption mode under the control of the central processing unit.

6. The portable electronic device with multimedia function as claimed in claim 5, wherein when the multimedia information management module determines the resolutions of multimedia files to be broadcasted are greater than the resolution of the electronic device, the central processing unit selects the high power consumption mode, and drives the projection module to project the multimedia signals onto the surface.

7. The portable electronic device with multimedia function as claimed in claim 5, wherein when the multimedia information management module determines the resolutions of multimedia files to be broadcasted are less than or equal to the resolution of the electronic device, the power management module remains in the low power consumption mode controlled by the central processing unit, and the multimedia signals are displayed on the electronic device.

8. The portable electronic device with multimedia function as claimed in claim 1, further includes a keypad module connected to the central processing unit and inputting operation commands to the central processing unit to control the multimedia information management module and the power management module.

9. The portable electronic device with multimedia function as claimed in claim 1, wherein the projection module includes a projection unit forming a image section on the surface and a sensing unit forming a control section on the surface, the control section is used to display the multimedia signals from the projection module, and the control section is used to operate the multimedia signals displayed on the image section.

10. A portable electronic device with multimedia function comprising:
a central processing unit;
a display area displaying multimedia signals of the electronic device;
a projection module electronically connected to the central processing unit, and including a projection unit to project the multimedia signals of the electronic device onto the display area to display the multimedia signals;
a multimedia information management module electronically connected to the central processing unit, classifying the multimedia signals and choosing to play the multimedia signals under the control of the central processing unit; and
a power management module electronically connected to the central processing unit, and setting power consumption mode under the control of the central processing unit in accordance with the classification of the multimedia signals format.

11. The portable electronic device with multimedia function as claimed in claim 10, wherein the projection module further includes a sensing unit forming a control section on the display area, and the projection unit forms a image section on the display area, the image section is used to display the multimedia signals from the projection module, and the control section is used to operate the multimedia signals displayed on the image section.

12. The portable electronic device with multimedia function as claimed in claim 11, wherein when the multimedia information management module plays the multimedia signals, the power management module selects a low power consumption mode or a high power consumption mode based on the multimedia format and the resolution of the multimedia signals.

13. The portable electronic device with multimedia function as claimed in claim 12, wherein when the power management module selects the low power consumption mode, the multimedia signals are displayed on the electronic device.

14. The portable electronic device with multimedia function as claimed in claim 12, wherein when the power management module selects the high power consumption mode, the central processing unit drives the projection unit of the projection module to project the multimedia signals onto the image section of the display area.

15. The portable electronic device with multimedia function as claimed in claim 12, wherein when the power management module selects the low power consumption mode, then the multimedia information management module compares the resolutions of the multimedia files with the screen resolution of the electronic device, and the power management power module selects the power consumption mode under the control of the central processing unit.

16. The portable electronic device with multimedia function as claimed in claim 15, wherein when the multimedia information management module determines the resolutions of multimedia files to be broadcasted are greater than the resolution of the electronic device, the central processing unit selects the high power consumption mode, and drives the projection module to project the multimedia signals onto the playing unit of the display area.

17. The portable electronic device with multimedia function as claimed in claim 15, wherein when the multimedia information management module determines the resolutions of multimedia files to be broadcasted are less than or equal to the resolution of the electronic device, the power management module remains in the low power consumption mode controlled by the central processing unit, and the multimedia signals are displayed on the electronic device.

18. The portable electronic device with multimedia function as claimed in claim 10, further includes a keypad module connected to the central processing unit and inputting operation commands to the central processing unit to control the multimedia information management module and the power management module.

19. The portable electronic device with multimedia function as claimed in claim 10, further includes a display module electronically connected to the central processing unit, the display module is used to display multimedia information.
